(19) United States
(12) Patent Application Publication
(10) Pub. No.: US 2015/0207231 A1
(43) Pub. Date: Jul. 23, 2015

(54) CO-LOCATED ANTENNAS AND AN ELECTRONIC DEVICE INCLUDING THE SAME

(71) Applicant: Nvidia Corporation, Santa Clara, CA (US)

(72) Inventors: Sung Hoon Oh, Santa Clara, CA (US); Joselito Gavilan, Santa Clara, CA (US); Warren Lee, Santa Clara, CA (US)

(73) Assignee: Nvidia Corporation, Santa Clara, CA (US)

(21) Appl. No.: 14/160,231

(22) Filed: Jan. 21, 2014

(51) Int. Cl. H01Q 7/00; H04B 1/40; H01Q 1/24

(52) U.S. Cl. CPC H01Q 7/00; H01Q 1/243; H04B 1/40

(57) ABSTRACT

Provided is an antenna system. The antenna system, in this aspect, includes a loop antenna element, the loop antenna element having a positive loop antenna terminal end and a negative loop antenna terminal end. The antenna system, in this embodiment, further includes an inverted-F antenna element co-located with the loop antenna element, the inverted-F antenna element having a positive inverted-F antenna terminal end and a negative inverted-F antenna terminal end located proximate the positive loop antenna terminal end and the negative loop antenna terminal end. In this antenna system embodiment, the positive loop antenna terminal end, negative loop antenna terminal end, positive inverted-F antenna terminal end and negative inverted-F antenna terminal end alternate between positive and negative terminals.

This application is directed, in general, to antennas and, more specifically, to co-located antennas for handheld electronic devices.

### BACKGROUND

Handheld electronic devices are becoming increasingly popular. Examples of handheld devices include handheld computers, cellular telephones, media players, and hybrid devices that include the functionality of multiple devices of this type, among others.

Due in part to their mobile nature, handheld electronic devices are often provided with wireless communications capabilities. Handheld electronic devices may use long-range wireless communications to communicate with wireless base stations. For example, cellular telephones may communicate using 2G Global System for Mobile Communication (commonly referred to as GSM) frequency bands at about 850 MHz, 900 MHz, 1800 MHz, and 1900 MHz, among possible others. Communication is also possible in the 3G Universal Mobile Telecommunication System (commonly referred to as UMTS, and more recently HSPA+) and 4G Long Term Evolution (commonly referred to as LTE) frequency bands which range from 700 MHz to 3800 MHz. Furthermore, communications can operate on channels with variable bandwidths of 1.4 MHz to 20 MHz for LTE, as opposed to the fixed bandwidths of GSM (0.2 MHz) and UMTS (5 MHz). Handheld electronic devices may also use short-range wireless communications links. For example, handheld electronic devices may communicate using the Wi-Fi® (IEEE 802.11) bands at about 2.4 GHz and 5 GHz, and the Bluetooth® band at about 2.4 GHz. Handheld devices with Global Positioning System (GPS) capabilities receive GPS signals at about 1575 MHz.

To satisfy consumer demand for small form factor wireless devices, manufacturers are continually striving to reduce the size of components that are used in these handheld electronic devices. For example, manufacturers have made attempts to miniaturize the antennas used in handheld electronic devices. Unfortunately, doing so within the confines of the wireless device package is challenging.

Accordingly, what is needed in the art is an antenna or antennas, and associated wireless handheld electronic device, which navigate the desires and problems associated with the foregoing.

### SUMMARY

One aspect provides an antenna system. The antenna system, in this aspect, includes a loop antenna element, the loop antenna element having a positive loop antenna terminal end and a negative loop antenna terminal end. The antenna system, in this embodiment, further includes an inverted-F antenna element co-located with the loop antenna element, the inverted-F antenna element having a positive inverted-F antenna terminal end and a negative inverted-F antenna terminal end located proximate the positive loop antenna terminal end and the negative loop antenna terminal end. In this antenna system embodiment, the positive loop antenna terminal end, negative loop antenna terminal end, positive inverted-F antenna terminal end and negative inverted-F antenna terminal end alternate between positive and negative terminals.

Another aspect provides an electronic device. The electronic device, in this aspect, includes storage and processing circuitry, input-output devices associated with the storage and processing circuitry, and wireless communications circuitry including an antenna system. The antenna system, in this aspect, includes: 1) a loop antenna element, the loop antenna element having a positive loop antenna terminal end and a negative loop antenna terminal end, and 2) an inverted-F antenna element co-located with the loop antenna element, the inverted-F antenna element having a positive inverted-F antenna terminal end and a negative inverted-F antenna terminal end located proximate the positive loop antenna terminal end and the negative loop antenna terminal end, wherein the positive loop antenna terminal end, negative loop antenna terminal end, positive inverted-F antenna terminal end and negative inverted-F antenna terminal end alternate between positive and negative terminals. One aspect provides an antenna system.

### BRIEF DESCRIPTION

Reference is now made to the following descriptions taken in conjunction with the accompanying drawings, in which:

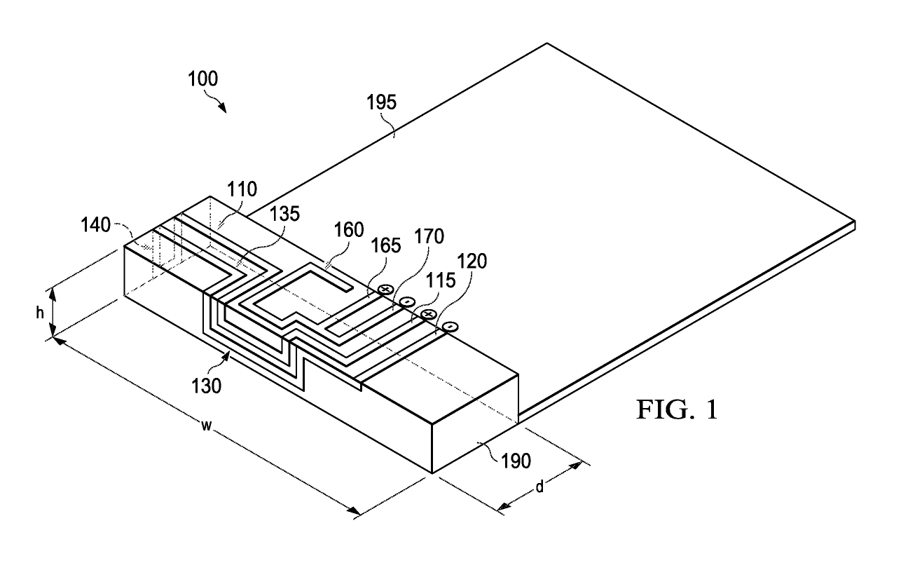

FIGS. 1, 2, 4 and 6 illustrate antenna systems manufactured and designed according to embodiments of the disclosure;

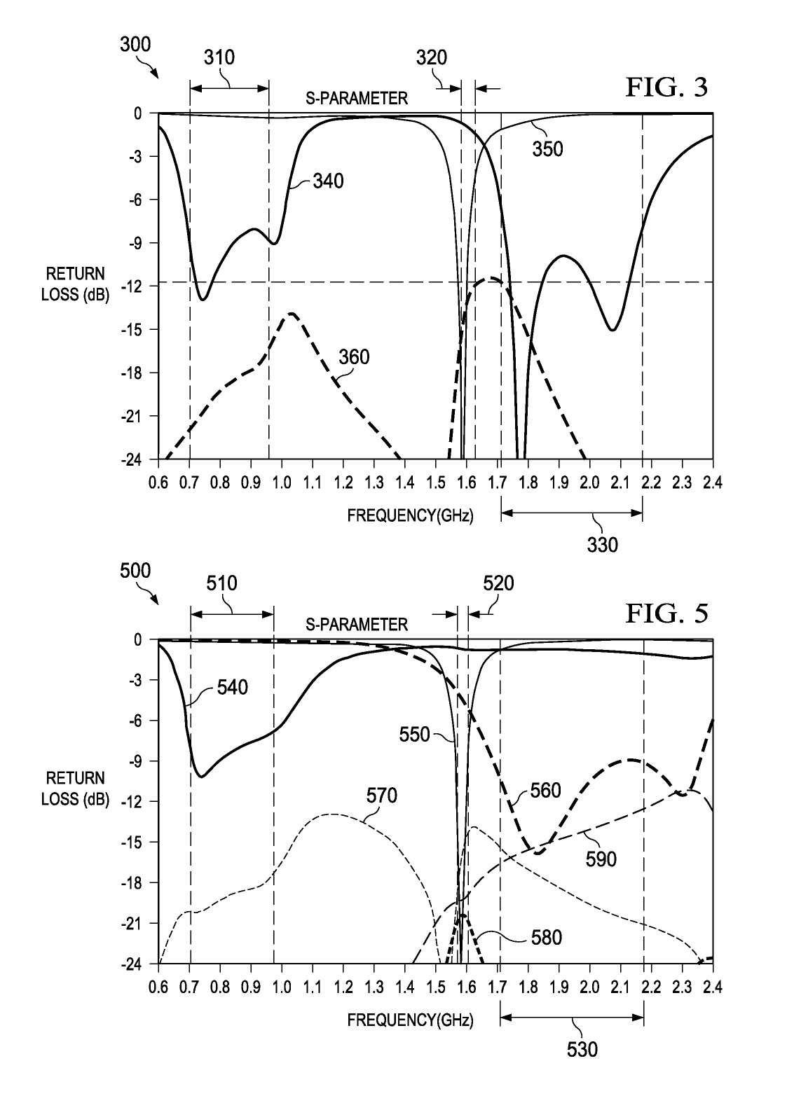

FIGS. 3, 5 and 7 illustrates S-parameter plots for antenna systems in accordance with the present disclosure; and

FIG. 8 illustrates a schematic diagram of electronic device in accordance with the disclosure.

### DETAILED DESCRIPTION

The present disclosure is based, at least in part, on the recognition that wireless networks are constantly evolving to increase speed and improve data communication, and that the latest cellular network, called Long Term Evolution (LTE) or 4G, not only operates in different frequency bands amongst carriers, but also between different regions. As a result, mobile electronic devices, such as smart phones, tablets and laptops, will need to support multiple LTE bands in addition to the legacy 3G (UMTS) and 2G (GSM) bands.

Table 1, set forth below, lists the 2G, 3G and 4G frequency bands for AT&T and Verizon, as well as the commonly deployed frequency bands in EMEA and APAC.

TABLE 1
Frequency Bands

| Band | Frequency | AT&T | Verizon | EMEA/APAC |
|---|---|---|---|---|
| 17 | 704-746 | 4G | | |
| 13 | 746-787 | | 4G | |
| 5 | 824-894 | 2G/3G | 2G/3G | |
| 8 | 880-960 | | | 2G/3G |
| 4 | 1710-1755, | 4G | | 4G |
| | 2110-2155 | | | |
| 3 | 1710-1880 | | | 2G/4G |
| 2 | 1850-1990 | 2G/3G | 2G/3G | |
| 1 | 1920-1980, | | | 3G/4G |
| | 2110-2170 | | | |
| 7 | 2500-2690 | | | 4G |

The addition of these frequency bands creates a significant challenge for antenna designers, since the antennas will now need to cover additional bands in the same allocated volume.

With this recognition in mind, the present disclosure acknowledged, for the first time, that co-located antennas capable of accommodating the aforementioned frequencies are plausible. The term “co-located” as used in this disclosure, means that the antennas as located proximate one another. The term “co-located” as used herein, does not include, and specifically excludes, antennas that are located on opposing ends of an electronic device package.

With this in mind, the present disclosure has acknowledged that co-located antennas can be achieved by alternating between positive and negative terminals of the co-located antennas. For example, if the first co-located antenna is a loop antenna element having a positive loop antenna terminal end and a negative loop antenna terminal end, and the second co-located antenna is an inverted-F antenna element having a positive inverted-F antenna terminal end and a negative inverted-F antenna terminal end, by alternating the positive and negative terminals of the loop antenna element and inverted-F antenna element, a high quality antenna system is achievable. By configuring the co-located antennas in the aforementioned manner, a highly isolated wide-bandwidth antenna system is achievable. Moreover, the aforementioned configurations, allow for a flexible radiofrequency (RF) front end architecture with separate feeds.

Turning to FIG. 1, illustrated is an antenna system 100 manufactured and designed according to one embodiment of the disclosure. The antenna system 100, in the embodiment of FIG. 1, includes a loop antenna element 110. The loop antenna element 110, in accordance with one embodiment, includes a positive loop antenna terminal end 115 and a negative loop antenna terminal end 120. In accordance with one embodiment of the present disclosure, the positive loop antenna terminal end 115 might directly connect to a positive terminal of a transmission line (not shown), such as a coaxial cable, microstrip, etc., to receive radio frequency signals from associated transceivers. The negative loop antenna terminal end 120, in accordance with one embodiment, might electrically connect to a negative terminal of the transmission line (not shown). Moreover, the negative loop antenna terminal end 120, in accordance with one embodiment of the disclosure, may connect to or form a portion of the conductive chassis 195.

The loop antenna element 110, in accordance with one embodiment of the disclosure, may include different loop antenna sections. In the embodiment of FIG. 1, the loop antenna element 110 includes approximately eighteen different sections, including a first loop antenna section 130, a second loop antenna section 135 and a third loop antenna section 140 (dotted in the view of FIG. 1). In the particular embodiment of FIG. 1, a major plane of the first loop antenna section 130 is located substantially perpendicular to a major plane of the second loop antenna section 135. Similarly, in the embodiment of FIG. 1, a major plane of the third loop antenna section 140 is perpendicular to the major planes of the first and second loop antenna sections 130, 135. This configuration, in one embodiment, is achievable by routing the loop antenna elements along different perpendicular edges of the chassis 195. The term “major plane”, as used throughout this disclosure, refers to a plane created by the two largest dimensions of any given antenna section (e.g., height and width) as opposed to a plane created using the third smallest dimension of a given antenna section (e.g., the thickness).

The antenna system 100 illustrated in FIG. 1 further includes an inverted-F antenna element 160 co-located with the loop antenna element 110. The inverted-F antenna element 160, in the embodiment of FIG. 1, has a positive inverted-F antenna terminal end 165 and a negative inverted-F antenna terminal end 170. In the particular embodiment shown, the positive inverted-F antenna terminal end 165 and the negative inverted-F antenna terminal end 170 are located proximate the positive loop antenna terminal end 115 and the negative loop antenna terminal end 120.

The inverted-F antenna element 160, similar to the loop antenna element 110, may have a number of different sections and remain within the purview of the disclosure. In the embodiment of FIG. 1, the inverted-F antenna element 160 has about six different sections. In the embodiment of FIG. 1, major planes of the different sections are coplanar. Other embodiments, however, may exist wherein the major planes of the different sections are not coplanar, including being perpendicular to one another.

In accordance with the present disclosure, the positive loop antenna terminal end 115, negative loop antenna terminal end 120, positive inverted-F antenna terminal end 165 and negative inverted-F antenna terminal end 170 alternate between positive and negative terminals. In the embodiment of FIG. 1, the ends 115, 120, 165 and 170 alternate (e.g., from an edge 190 of the chassis 195) as follows: negative loop antenna terminal end 120/positive loop antenna terminal end 115/negative inverted-F antenna terminal end 170/positive inverted-F antenna terminal end 165. In this embodiment, and depending on the different lengths of the loop antenna element 110 and inverted-F antenna element 160, the loop antenna element 110 may be configured to operate in a 704-960 MHz lower band, and the inverted-F antenna element 160 may be configured to operate in a 1575-1610 MHz GPS and GLONASS band. As will be evident further below, other embodiments exist wherein the loop antenna element 110 may also be configured to operate in the 1575-1610 MHz GPS and GLONASS band or the 1710-2170 MHz higher band. Additionally, as will be evident further below, other embodiments exist wherein the inverted-F antenna element 160 may also be configured to operate in the 1710-2170 MHz higher band.

An antenna system, such as the antenna system 100 illustrated in FIG. 1, or many other antennas manufactured in accordance with the disclosure, may be configured to fit within existing antenna volumes. For instance, in one embodiment, the antenna system 100 fits within an existing volume defined by a width (w), a height (h) and a depth (d). Such a volume, in many embodiments, forms the shape of a cube, as opposed to a more random volume. In accordance with one embodiment, the loop antenna element 110 and inverted-F antenna element 160 are co-located to operate within a volume of less than about 30 cm³. In yet another embodiment, the loop antenna element 110 and inverted-F antenna element 160 are co-located to operate within a volume of less than about 3 cm³, and in yet another embodiment less than about 2 cm³.

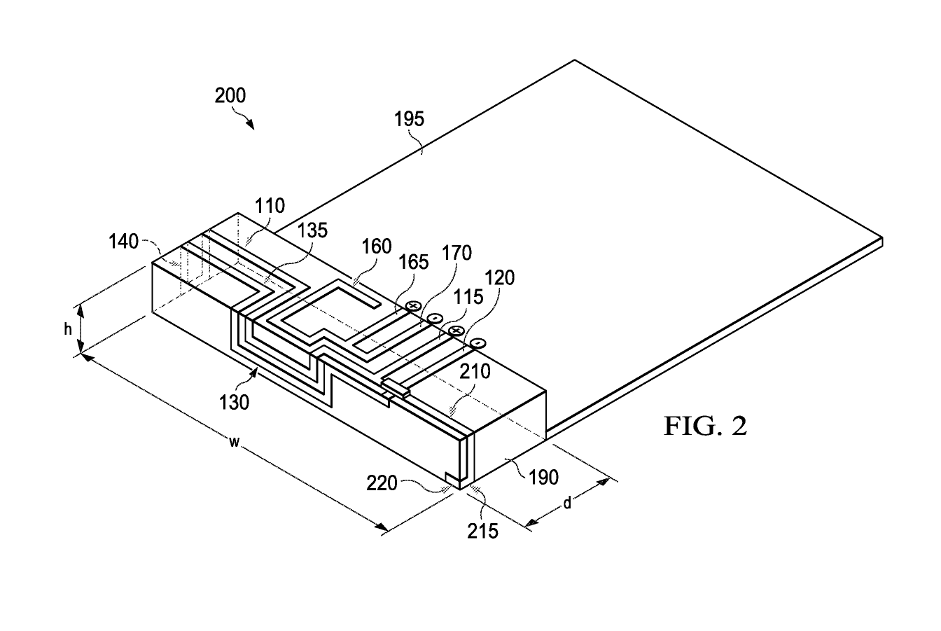

FIG. 2 illustrates alternative aspects of a representative embodiment of an antenna system 200 in accordance with embodiments of the disclosure. Where used, like reference numerals indicate similar features to the antenna system 100 of FIG. 1. The antenna system 200 of FIG. 2 differs, for the most part, from the antenna system 100 of FIG. 1, in that a monopole antenna element 210 is coupled to the loop antenna element 110. In the particular embodiment of FIG. 2, the monopole antenna element 210 is coupled proximate the positive loop antenna terminal end 115. Moreover, for the embodiment of FIG. 2, the monopole antenna element 210 bridges, whether above or below, the negative loop antenna terminal end 120. The bridging of the negative loop antenna terminal end 120 by the monopole antenna element 210 is a function of their relative placement with regard to the edges (e.g., edge 190) of the chassis 195.

The monopole antenna element 210, similar to the loop antenna element 110, may have a number of different sections and remain within the purview of the disclosure. In the embodiment of FIG. 2, the monopole antenna element 210 has four different sections, including a first monopole antenna section 215 and a second monopole antenna section 220. Further to this embodiment, a major plane of the first monopole antenna section 215 is located substantially perpendicular to a major plane of the second monopole antenna section 220.

Particular to the embodiment of FIG. 2, the monopole antenna element 210 is configured to operate in a 1710-2170 MHz higher band. Accordingly, the antenna structure 200 of FIG. 2 is configured to operate in the 704-960 MHz lower band, the 1575-1610 MHz GPS and GLONASS band, and the 1710-2170 MHz higher band. Moreover, the antenna structure 200 is capable of doing so within existing antenna volumes.

FIG. 3 illustrates an S-parameter plot 300 for an antenna system in accordance with the present disclosure. The S-parameter plot 300 might, in one embodiment, be representative of the antenna system 200 of FIG. 2. Specifically, plot 300 illustrates the frequencies attainable in the lower band bandwidth 310, as well as the frequencies attainable in the GPS and GLONASS bandwidth 320 and higher band bandwidth 330. In the plot 300 of FIG. 3, the line 340 is representative of the loop antenna element 110 and the monopole antenna element 210, and the line 350 is representative of the inverted-F antenna element 160. Additionally, for these given ranges, the return loss values for the desirable frequencies are well below −6, which is outstanding for co-located antenna. As is clear from the plot 300, the return loss values for the 704-960 MHz lower band and the 1575-1610 MHz GPS and GLONASS band are actually less than about −9. Further illustrated in FIG. 3, is a line 360 representative of the isolation that exists for the antenna system 200 of FIG. 2. As is clear, the isolation values are below about −12 for all the frequencies covered by the antenna system 300.

FIG. 4 illustrates alternative aspects of a representative embodiment of an antenna system 400 in accordance with embodiments of the disclosure. Where used, like reference numerals indicate similar features to the antenna system 100 of FIG. 1. The antenna system 400 of FIG. 4 differs, for the most part, from the antenna system 100 of FIG. 1, in that it additionally has a second inverted-F antenna element 410 co-located with the loop antenna element 110 and inverted-F antenna element 160. In the particular embodiment of FIG. 4, the second inverted-F antenna element 410 is located on the outside of the loop antenna element 110.

The second inverted-F antenna element 410, in the embodiment of FIG. 4, has a second positive inverted-F antenna terminal end 415 and a second negative inverted-F antenna terminal end 420. In the particular embodiment shown, the second positive inverted-F antenna terminal end 415 and second negative inverted-F antenna terminal end 420 do not alternate relative to the positive loop antenna terminal end 115, negative loop antenna terminal end 120, positive inverted-F antenna terminal end 165 and negative inverted-F antenna terminal end 170. Particular to the embodiment of FIG. 4, the second negative inverted-F antenna terminal end 420 is proximate the negative loop antenna terminal end 120. Accordingly, in the embodiment of FIG. 4, the ends 115, 120, 165, 170, 415 and 420 are laid out (e.g., from the edge 190) as follows: second positive inverted-F antenna terminal end 415/second negative inverted-F antenna terminal end 420/negative loop antenna terminal end 120/positive loop antenna terminal end 115/negative inverted-F antenna terminal end 170/positive inverted-F antenna terminal end 165.

The second inverted-F antenna element 410, similar to the loop antenna element 110, may have a number of different sections and remain within the purview of the disclosure. In the embodiment of FIG. 4, the second inverted-F antenna element 410 has about three different sections, including a first section 430 and a second section 435. In the embodiment of FIG. 4, major planes of the first section 430 and second section 435 are perpendicular to one another. Other embodiments, however, may exist wherein the major planes of the different sections are coplanar.

Particular to the embodiment of FIG. 4, the second inverted-F antenna element 410 is configured to operate in a 1710-2170 MHz higher band. Accordingly, the antenna structure 400 of FIG. 4 is configured to operate in the 704-960 MHz lower band, the 1575-1610 MHz GPS and GLONASS band, and the 1710-2170 MHz higher band. Moreover, the antenna structure 400 is capable of doing so within existing antenna volumes.

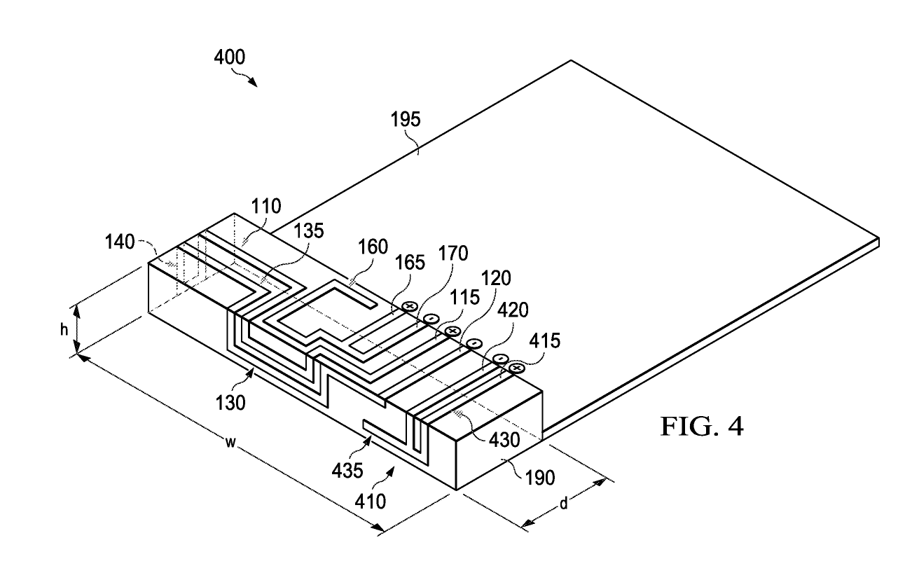

FIG. 5 illustrates an S-parameter plot 500 for an antenna system in accordance with the present disclosure. The S-parameter plot 500 might, in one embodiment, be representative of the antenna system 400 of FIG. 4. Specifically, plot 500 illustrates the frequencies attainable in the lower band bandwidth 510, as well as the frequencies attainable in the GPS and GLONASS bandwidth 520 and higher band bandwidth 530. In the plot 500 of FIG. 5, the line 540 is representative of the loop antenna element 110, the line 550 is representative of the inverted-F antenna element 160, and line 560 is representative of the second inverted-F antenna element 410. Additionally, for these given ranges, the return loss values for the desirable frequencies are well below −6, which is outstanding for co-located antenna. As is clear from the plot 500, the return loss value for the 1575-1610 MHz GPS and GLONASS band and the 1710-2170 MHz higher band is actually less than about −9.

Further illustrated in FIG. 5, are the lines 570, 580, and 590 representative of the isolation that exists for the antenna system 400 of FIG. 4. The line 570 represents the isolation between the loop antenna element 110 and the inverted-F antenna element 160. As is clear from the line 570, the isolation values are below about −12 for all the frequencies covered by the antenna system 400. The line 580 represents the isolation between the inverted-F antenna element 160 and the second inverted-F antenna element 410. As is clear from line 580, the isolation values are below about −20 for all the frequencies covered by the antenna system 400. The line 590 represents the isolation between the loop antenna element 110 and the second inverted-F antenna element 410. As is clear from line 590, the isolation values are below about −12 for all the frequencies covered by the antenna system 400.

FIG. 6 illustrates alternative aspects of a representative embodiment of an antenna system 600 in accordance with embodiments of the disclosure. Where used, like reference numerals indicate similar features to the antenna systems 100 of FIGS. 1 and 400 of FIG. 4. The antenna system 600 of FIG. 6 differs, for the most part, from the antenna systems 100 of FIGS. 1 and 400 of FIG. 4, in that the positive loop antenna terminal end 115 and the negative loop antenna terminal end 120 of FIG. 6 are reversed as they relate to the positive loop antenna terminal end 115 and negative loop antenna terminal end 120 of FIG. 1 and FIG. 4.

Accordingly, for the embodiment of FIG. 6, the positive loop antenna terminal end 115, negative loop antenna terminal end 120, second positive inverted-F antenna terminal end 415, and second negative inverted-F antenna terminal end 420 alternate positive and negative terminals with regard to one another. Specifically, in the embodiment of FIG. 6, the ends 115, 120, 415 and 420 alternate (e.g., from an edge 190 of the chassis 195) as follows: second positive inverted-F antenna terminal end 415/second negative inverted-F antenna terminal end 420/positive loop antenna terminal end 115/negative loop antenna terminal end 120.

Particular to the embodiment of FIG. 6, the loop antenna element 110 is configured to operate in the 704-960 MHz lower band. Further to the embodiment of FIG. 6, the second inverted-F antenna element 410 is configured to operate in a 1710-2170 MHz higher band. Accordingly, the antenna structure 600 of FIG. 6 is configured to operate in the 704-960 MHz lower band and the 1710-2170 MHz higher band. Moreover, the antenna structure 600 is capable of doing so within existing antenna volumes.

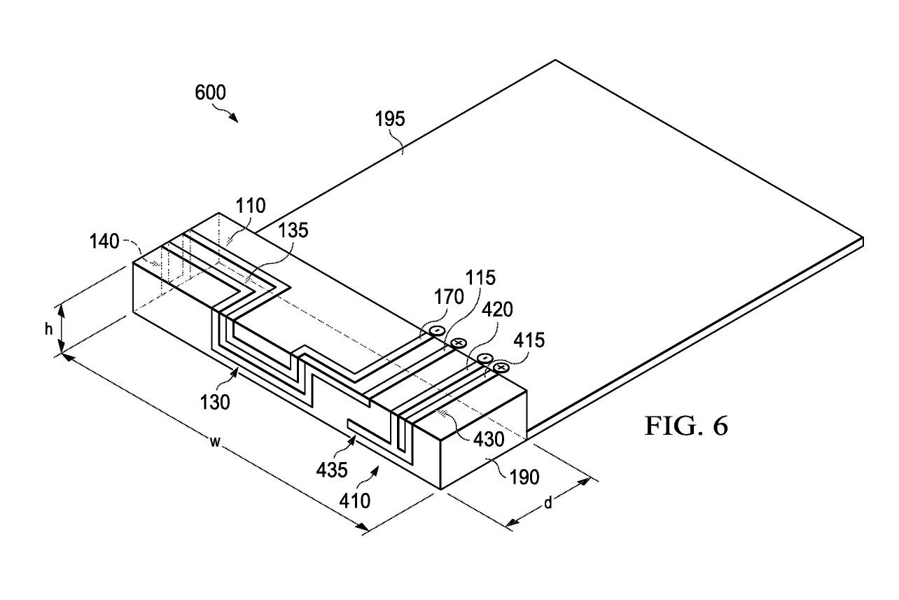

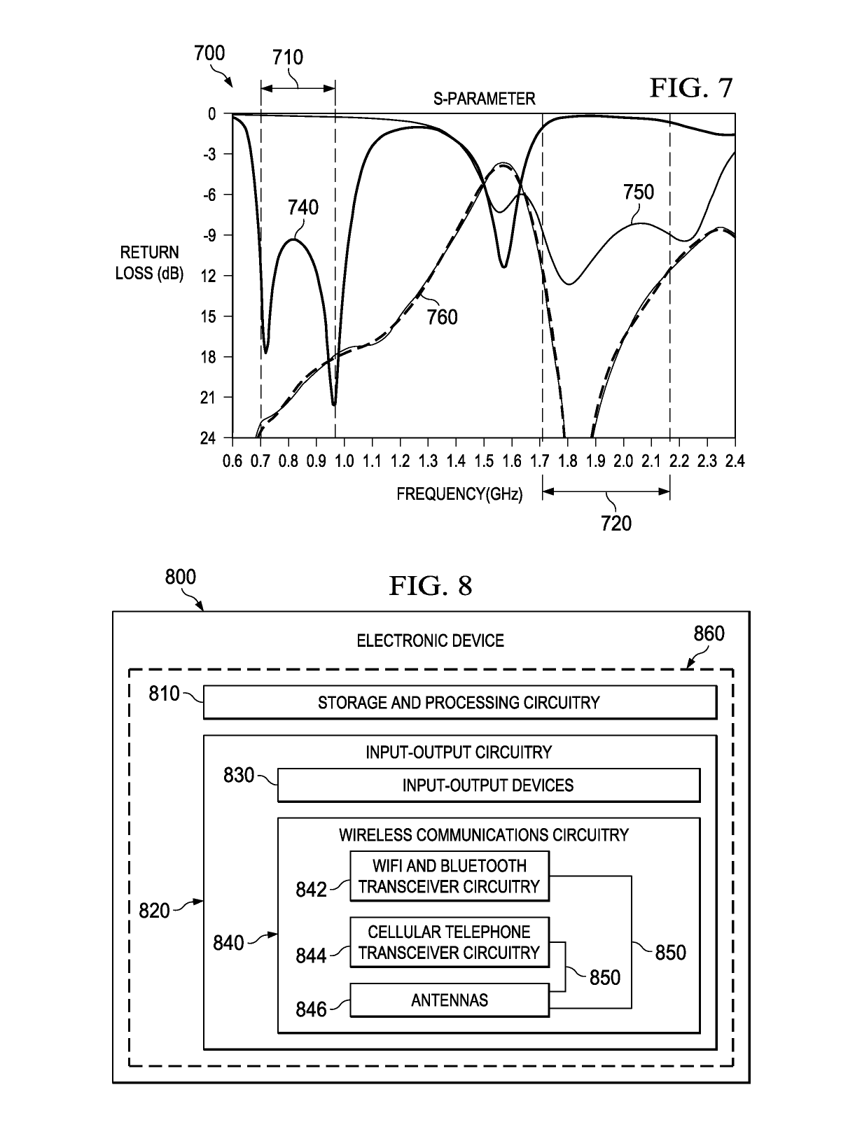

FIG. 7 illustrates an S-parameter plot 700 for an antenna system in accordance with the present disclosure. The S-parameter plot 700 might, in one embodiment, be representative of the antenna system 600 of FIG. 6. Specifically, plot 700 illustrates the frequencies attainable in the lower band bandwidth 710, as well as the frequencies attainable in the higher band bandwidth 720. In the plot 700 of FIG. 7, the line 740 is representative of the loop antenna element 110, and the line 750 is representative of the second inverted-F antenna element 410. Additionally, for these given ranges, the return loss values for the desirable frequencies are well below −6, which is outstanding for co-located antenna. As is clear from the plot 700, the return loss value for the 704-960 MHz lower band and the 1710-2170 MHz higher band is actually less than about −9. Further illustrated in FIG. 7, is a line 760 representative of the isolation that exists for the antenna system 600 of FIG. 6. As is clear, the isolation values are below about −18 for the 704-960 MHz lower band and below about −9 for the 1710-2170 MHz higher band of the antenna system 600.

FIG. 8 shows a schematic diagram of electronic device 800 manufactured in accordance with the disclosure. Electronic device 800 may be a portable device such as a mobile telephone, a mobile telephone with media player capabilities, a handheld computer, a remote control, a game player, a global positioning system (GPS) device, a laptop computer, a tablet computer, an ultraportable computer, a combination of such devices, or any other suitable portable electronic device.

As shown in FIG. 8, electronic device 800 may include storage and processing circuitry 810. Storage and processing circuitry 810 may include one or more different types of storage such as hard disk drive storage, nonvolatile memory (e.g., flash memory or other electrically-programmable-read-only memory), volatile memory (e.g., static or dynamic random-access-memory), etc. Processing circuitry in the storage and processing circuitry 810 may be used to control the operation of device 800. The processing circuitry may be based on a processor such as a microprocessor or other suitable integrated circuits. With one suitable arrangement, storage and processing circuitry 810 may be used to run software on device 800, such as internet browsing applications, voice-over-internet-protocol (VOIP) telephone call applications, email applications, media playback applications, operating system functions, etc. Storage and processing circuitry 810 may be used in implementing suitable communications protocols.

Communications protocols that may be implemented using storage and processing circuitry 810 include, without limitation, internet protocols, wireless local area network protocols (e.g., IEEE 802.11 protocols—sometimes referred to as WiFi®), protocols for other short-range wireless communications links such as the Bluetooth® protocol, protocols for handling 3G communications services (e.g., using wide band code division multiple access techniques), 2G cellular telephone communications protocols, etc. Storage and processing circuitry 810 may implement protocols to communicate using 2G cellular telephone bands at 850 MHz, 900 MHz, 1800 MHz, and 1900 MHz (e.g., the main Global System for Mobile Communications or GSM cellular telephone bands) and may implement protocols for handling 3G and 4G communications services.

Input-output device circuitry 820 may be used to allow data to be supplied to device 800 and to allow data to be provided from device 800 to external devices. Input-output devices 830 such as touch screens and other user input interfaces are examples of input-output circuitry 820. Input-output devices 830 may also include user input-output devices such as buttons, joysticks, click wheels, scrolling wheels, touch pads, key pads, keyboards, microphones, cameras, etc. A user can control the operation of device 800 by supplying commands through such user input devices. Display and audio devices may be included in devices 830 such as liquid-crystal display (LCD) screens, light-emitting diodes (LEDs), organic light-emitting diodes (OLEDs), and other components that present visual information and status data. Display and audio components in input-output devices 830 may also include audio equipment such as speakers and other devices for creating sound. If desired, input-output devices 830 may contain audio-video interface equipment such as jacks and other connectors for external headphones and monitors.

Wireless communications circuitry 840 may include radio-frequency (RF) transceiver circuitry formed from one or more integrated circuits, power amplifier circuitry, low-noise input amplifiers, passive RF components, one or more antennas, and other circuitry for handling RF wireless signals. Wireless signals can also be sent using light (e.g., using infrared communications). Wireless communications circuitry 840 may include radio-frequency transceiver circuits for handling multiple radio-frequency communications bands. For example, circuitry 840 may include transceiver circuitry 842 that handles 2.4 GHz and 5 GHz bands for WiFi® (IEEE 802.11) communications and the 2.4 GHz Bluetooth® communications band. Circuitry 840 may also include cellular telephone transceiver circuitry 844 for handling wireless communications in cellular telephone bands such as the GSM bands at 850 MHz, 900 MHz, 1800 MHz, and 1900 MHz, as well as the UMTS, HSPA+ and LTE bands (as examples). Wireless communications circuitry 840 can include circuitry for other short-range and long-range wireless links if desired. For example, wireless communications circuitry 840 may include global positioning system (GPS) receiver equipment, wireless circuitry for receiving radio and television signals, paging circuits, etc. In WiFi® and Bluetooth® links and other short-range wireless links, wireless signals are typically used to convey data over tens or hundreds of feet. In cellular telephone links and other long-range links, wireless signals are typically used to convey data over thousands of feet or miles.

Wireless communications circuitry 840 may include antennas 846. Device 800 may be provided with any suitable number of antennas. There may be, for example, one antenna, two antennas, three antennas, or more than three antennas, in device 800. For example, in one embodiment, the antennas 846 form at least a portion of an antenna system, such as the antenna systems discussed above with regard to FIGS. 1-7, among others. In accordance with the disclosure, the antennas may handle communications over multiple communications bands. Different types of antennas may be used for different bands and combinations of bands. For example, it may be desirable to form a multi-band antenna for forming a local wireless link antenna, a multi-band antenna for handling cellular telephone communications bands, and a single band antenna for forming a global positioning system antenna (as examples).

Paths 850, such as transmission line paths, may be used to convey radio-frequency signals between transceivers 842 and 844, and antennas 846. Radio-frequency transceivers such as radio-frequency transceivers 842 and 844 may be implemented using one or more integrated circuits and associated components (e.g., power amplifiers, switching circuits, matching network components such as discrete inductors and capacitors, and integrated circuit filter networks, etc.). These devices may be mounted on any suitable mounting structures. With one suitable arrangement, transceiver integrated circuits may be mounted on a printed circuit board. Paths 850 may be used to interconnect the transceiver integrated circuits and other components on the printed circuit board with antenna structures in device 800. Paths 850 may include any suitable conductive pathways over which radio-frequency signals may be conveyed including transmission line path structures such as coaxial cables, microstrip transmission lines, etc.

The device 800 of FIG. 8 further includes a chassis 860. The chassis 860 may be used for mounting/supporting electronic components such as a battery, printed circuit boards containing integrated circuits and other electrical devices, etc. For example, in one embodiment, the chassis 860 positions and supports the storage and processing circuitry 810, and the input-output circuitry 820, including the input-output devices 830 and the wireless communications circuitry 840 (e.g., including the WIFI and Bluetooth transceiver circuitry 842, the cellular telephone circuitry 844, and the antennas 846.

The chassis 860, in one embodiment, is a metal chassis. For example, the chassis 860 may be made of various different metals, such as aluminum. Chassis 860 may be machined or cast out of a single piece of material, such as aluminum. Other methods, however, may additionally be used to form the chassis 860. In certain embodiments, the chassis 860 will couple to at least a portion of the antennas 846.

Those skilled in the art to which this application relates will appreciate that other and further additions, deletions, substitutions and modifications may be made to the described embodiments.

What is claimed is:

1. An antenna system, comprising:
a loop antenna element, the loop antenna element having a positive loop antenna terminal end and a negative loop antenna terminal end; and
an inverted-F antenna element co-located with the loop antenna element, the inverted-F antenna element having a positive inverted-F antenna terminal end and a negative inverted-F antenna terminal end located proximate the positive loop antenna terminal end and the negative loop antenna terminal end, wherein the positive loop antenna terminal end, negative loop antenna terminal end, positive inverted-F antenna terminal end and negative inverted-F antenna terminal end alternate between positive and negative terminals.

2. The antenna system of claim 1, wherein the positive loop antenna terminal end, negative loop antenna terminal end, positive inverted-F antenna terminal end and negative inverted-F antenna terminal end alternate between positive and negative terminals as follows:
negative loop antenna terminal end/positive loop antenna terminal end/negative inverted-F antenna terminal end/positive inverted-F antenna terminal end.

3. The antenna system as recited in claim 2, wherein the loop antenna element is configured to operate in a 704-960 MHz lower band, and the inverted-F antenna element is configured to operate in a 1575-1610 MHz GPS and GLONASS band.

4. The antenna system as recited in claim 3, further including a monopole antenna element coupled proximate the positive loop antenna terminal end, the monopole antenna element configured to operate in a 1710-2170 MHz higher band.

5. The antenna system as recited in claim 4, wherein the monopole antenna element bridges the negative loop antenna terminal end.

6. The antenna system as recited in claim 3, wherein the inverted-F antenna element is a first inverted-F antenna element, and further including a second inverted-F antenna element co-located with the loop antenna element and the first inverted-F antenna element, the second inverted-F antenna element having a second positive inverted-F antenna terminal end and a second negative inverted-F antenna terminal end.

7. The antenna system as recited in claim 6, wherein the positive loop antenna terminal end, negative loop antenna terminal end, positive inverted-F antenna terminal end, negative inverted-F antenna terminal end, second positive inverted-F antenna terminal end and second negative inverted-F antenna terminal end alternate between positive and negative terminals as follows:
second positive inverted-F antenna terminal end/second negative inverted-F antenna terminal end/negative loop antenna terminal end/positive loop antenna terminal end/negative inverted-F antenna terminal end/positive inverted-F antenna terminal end.

8. The antenna system as recited in claim 7, wherein the loop antenna element is configured to operate in a 704-960 MHz lower band, the first inverted-F antenna element is configured to operate in a 1575-1610 MHz GPS and GLONASS band, and the second inverted-F antenna element is configured to operate in a 1710-2170 MHz higher band.

9. The antenna system of claim 1, wherein the positive loop antenna terminal end, negative loop antenna terminal end, positive inverted-F antenna terminal end and negative inverted-F antenna terminal end alternate between positive and negative terminals as follows:
positive inverted-F antenna terminal end/negative inverted-F antenna terminal end/positive loop antenna terminal end/negative loop antenna terminal end.

10. The antenna system of claim 9, wherein the loop antenna element is configured to operate in a 704-960 MHz lower band and a 1575-1610 MHz GPS and GLONASS band, and the inverted-F antenna element is configured to operate in a 1710-2170 MHz higher band.

11. The antenna system of claim 1, wherein the loop antenna element and inverted-F antenna element are co-located proximate an edge of an electronic device.

12. The antenna system of claim 1 wherein the loop antenna element and inverted-F antenna element are co-located within a volume of less than about 3 cm³.

13. An electronic device, comprising:
storage and processing circuitry;
input-output devices associated with the storage and processing circuitry; and
wireless communications circuitry including an antenna system, the antenna system including;
a loop antenna element, the loop antenna element having a positive loop antenna terminal end and a negative loop antenna terminal end; and
an inverted-F antenna element co-located with the loop antenna element, the inverted-F antenna element having a positive inverted-F antenna terminal end and a negative inverted-F antenna terminal end located proximate the positive loop antenna terminal end and the negative loop antenna terminal end, wherein the positive loop antenna terminal end, negative loop antenna terminal end, positive inverted-F antenna terminal end and negative inverted-F antenna terminal end alternate between positive and negative terminals.

14. The electronic device of claim 13, wherein the positive loop antenna terminal end, negative loop antenna terminal end, positive inverted-F antenna terminal end and negative inverted-F antenna terminal end alternate between positive and negative terminals as follows:
negative loop antenna terminal end/positive loop antenna terminal end/negative inverted-F antenna terminal end/positive inverted-F antenna terminal end.

15. The electronic device as recited in claim 14, wherein the loop antenna element is configured to operate in a 704-960 MHz lower band, and the inverted-F antenna element is configured to operate in a 1575-1610 MHz GPS and GLONASS band.

16. The electronic device as recited in claim 15, further including a monopole antenna element coupled proximate the positive loop antenna terminal end, the monopole antenna element configured to operate in a 1710-2170 MHz higher band.

17. The electronic device as recited in claim 14, wherein the inverted-F antenna element is a first inverted-F antenna element, and further including a second inverted-F antenna element co-located with the loop antenna element and the first inverted-F antenna element, the second inverted-F antenna element having a second positive inverted-F antenna terminal end and a second negative inverted-F antenna terminal end, and further wherein the positive loop antenna terminal end, negative loop antenna terminal end, positive inverted-F antenna terminal end, negative inverted-F antenna terminal end, second positive inverted-F antenna terminal end and second negative inverted-F antenna terminal end alternate between positive and negative terminals as follows:
second positive inverted-F antenna terminal end/second negative inverted-F antenna terminal end/negative loop antenna terminal end/positive loop antenna terminal end/negative inverted-F antenna terminal end/positive inverted-F antenna terminal end.

18. The electronic device of claim 13, wherein the positive loop antenna terminal end, negative loop antenna terminal end, positive inverted-F antenna terminal end and negative inverted-F antenna terminal end alternate between positive and negative terminals as follows:
positive inverted-F antenna terminal end/negative inverted-F antenna terminal end/positive loop antenna terminal end/negative loop antenna terminal end.

19. The electronic device of claim 13 wherein the loop antenna element and inverted-F antenna element are co-located within a volume of less than about 3 cm³.

20. The electronic device of claim 13, wherein the storage and processing circuitry, input-output devices, and wireless communications circuitry are positioned within a conductive chassis, and further wherein the negative loop antenna terminal end and negative inverted-F antenna terminal end electrically connect to the conductive chassis.
